(19) United States
(12) Patent Application Publication
(10) Pub. No.: US 2006/0112352 A1
(43) Pub. Date: May 25, 2006

(54) Video program menu system and menu system control device thereof

(76) Inventors: Chao-Tsung Tseng, Taipei (TW); Yao Wei Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/028,057

(22) Filed: Jan. 4, 2005

(30) Foreign Application Priority Data
Nov. 25, 2004 (TW) 093136343

(51) Int. Cl. G06F 9/00; G06F 3/00

(52) U.S. Cl. 715/810

(57) ABSTRACT

The present invention relates to a video program menu system and menu control device thereof. The main structure comprises a video converting device, a display screen, and a menu control device. The video converting device can be used to receive at least one video on demand program data and comprises a plurality of program class name fields, a plurality of program data display sections, and a program preview section therein. A main menu and a sub-menu can be arranged on the display screen. At least one program class name fields will be displayed on the main menu, and a plurality of program data display sections and a program preview display section are displayed on the sub-menu. The program data display section is used to show a name or description of one of the programs. When a consumer chooses to highlight one of the program data display sections, program preview content of the highlighted program data display section can be displayed in the program preview display section. Further, direction controls of the menu control device will be redefined to increase convenience in using the control device. Thereby, not only it is convenient for consumers to search, preview, or order programs or movies to be watched, but best performance of the program advertisements can be made.

### FIELD OF THE INVENTION

The present invention is related to a video program menu system and menu control device thereof, more particularly to a menu control device is not only convenient for consumers to search, preview, or order programs or movies to be watched, but best performance of the program advertisements can be made.

### BACKGROUND

Accordingly, by the improvement of video industry, a large amount of video programs, such as movies, dramas, news, sports, cartoons, karaoke, teaching, financial analysis, shopping, etc., are provided to public consumers to understand and choose to watch any time by channel vendors, system vendors, network vendors, or hotel vendors.

However, how to let consumers easy to choose programs or movies to be watches or bought from a variety of programs but not to waste time and effort to pick up programs without destination is an object chased and expected by vendors or consumers.

Therefore, vendors nowadays provide a video on demand (VOD) system or an interactive program guides (IPG) system which mainly classifies various programs are depending on their properties and show the classified program classes and corresponding program names by paper or directly by a display screen to provide consumers to view and choose program content to be watched conveniently any time. All program content or movie content are mainly stored in a video server and sent to the display screen or a data storage device of consumers through a transferring line at correct time after obtaining a notification of watching or ordering from consumers to ensure to provide to consumers to watch.

Please refer to FIG. 1 and FIG. 2A to FIG. 2E, which are operating flow chart of a prior art video program menu system and diagrams of screen display in each operating step, respectively. As shown in the figures, when a consumer wants to process the VOD or IPG system in a state which a display screen 20 is on, the display screen 20 will appear a main menu 21. Various program class menus 210 are shown in the main menu 21, such as romance 211, comedy 213, drama 215, action 217, crime 219, etc., as shown in FIG. 2A.

In step 101, the consumer can operate the cursor to click a position by a menu control device (e.g. a remote controlling device), for example, using the cursor to choose a program class, action 217, in FIG. 2A to enter a next menu interface, as shown in FIG. 2B.

In step 102 and FIG. 2B, the display screen 20 appears a program name list 23 automatically. The program name list 23 includes a plurality of program name fields 230, such as Speed 231, Air Force One 233, Taxi, 235, The One 237, and Brave Heart 239 shown in the figure. Every program name field 230 can be used to show a name of the program.

In step 103 and FIG. 2C, the display screen 20 appears a program preview picture 251 and program text description 253 automatically. The program preview picture 251 and the program text description 253 show and highlight a program picture and associated description related to the program name field, such as content introduction, director, actor/actress in a leading role, length of movie, playing time, or movie rate, etc.

In step 104 and FIG. 2D, the display screen 20 appears a program preview short 27 automatically. The content shown in the program preview short 27 is a program pilot film associated with the highlighted program name field.

In step 105 and FIG. 2E, if the chosen program or movie to be watched is a pay system, the display screen 20 will appear an order menu 29 automatically. It can include various ordering conditions or confirmation, such as a program name, order price, length of movie, playing time, parental control code, payment choice, etc. Further, choosing an ordering function key 291 to confirm whether agree to order this program or movie or not. If yes, continue to step 106. If not, proceed step 115.

In step 115, the consumer chooses whether to continue the VOD or IPG system. If no, exit and end the previous mentioned system. If yes, continue to step 116.

In step 116, the consumer decides whether to continue to choose programs or movies to be watched in the same program class, such as action 217. If yes, return to step 102, and re-choose the program name list 23 to be viewed in the same program class. If not, return to step 101, and re-choose in the main menu 21.

In step 106, the consumer finishes an ordering process of the content of the program or movie through the ordering menu 29.

In step 107, the consumer can watch the content of the chosen or ordered program or movie through the display screen 20 right away or later on at a specified time.

Of course, if VOD and IPG are not pay systems, after completing step 104 to device the program to be watched, proceed step 107 directly to watch the chosen program.

Although in the previous mentioned video program menu system, the consumer can pick out the program or movie which he/she is interested in watching, there still existed the following shortcomings:
1. When the consumer chooses the program or movie, he/she has to repeatedly proceed the program class menu or program menu process, then after a highlighting program name field process, corresponding program preview short is shown. It is not only inconvenient in use but also loses time in operating.
2. The program preview short only can be shown after highlighting the program name field, and choosing is only based on the program name, the effect of the program advertisement is neither real-time nor outstanding, the best advertisement effect cannot be done.
3. All of the related description of the program cannot be shown on the screen display at the same time. For example, a program preview short is shown, meanwhile other program name fields cannot be viewed. A back process must be done, and then they are shown. It is inconvenient in use.
4. Up, down, left, and right direction keys of the menu controller can only control choosing up, down, left, and right moving positions of the cursor. If a wrong direction key is pressed at the border position, the cursor will not move. It is inconvenient in use and not human-friendly.

### SUMMARY OF THE INVENTION

Accordingly, how to design a video program menu system and menu control device thereof for effectively resolving the shortcomings of the previous mentioned not only for consumers to preview or buy programs or movies to be watched but only for program advertisements to have the best performance is the key point of the present invention.

It is a primary object of the present invention to provide a video program menu system which the program class name fields of the main menu of and the program data display section and program preview display section of the sub-menu of can be shown on the same screen display. Therefore, all related information of the programs can be viewed on a screen display at the same time. Thereby it is convenient for consumers to choose the class, program, or movie to be watched quickly and easily.

It is a secondary object of the present invention to provide a video program menu system of which shown content of the sub-menu is decided by the choice of the program class name fields in the main menu. A plurality of program data display sections in the sub-menu can be arranged the peripheral positions around the sub-menu. By choosing or traversing one of the program data display sections, related program preview short will be shown in the program preview display section at the same time. Therefore, it is fast to view the program preview short. It is not only convenient for consumers to choose programs or movies to be watched, but also the best performance of the program advertisements can be achieved.

It is another object of the present invention to provide a video program menu system wherein the content of the program class name fields of the main menu can be adjusted according to their preferences by consumers to achieve an object of fast searching and managing.

It is another object of the present invention to provide a menu control device of the video program menu system. The direction operating setup of its cursor position is set based on logical thoughts of normal people such that consumers can feel freer to use such a manipulating interface in operating to fully achieve an object of human-friendly interface.

### BRIEF DESCRIPTION OF DRAWINGS

FIG. 1 is a operating flow chart of a prior art video program menu system;

FIG. 2A to FIG. 2E are respectively diagrams of the screen display of the prior art video program menu system in each operating step;

FIG. 3A is a diagram of the screen display of a preferred embodiment of the present invention video program menu system;

FIG. 3B is a diagram of the screen display of the present invention video program menu system in operating process;

FIG. 4 is a diagram of the screen display of another embodiment of the present invention video program menu system;

FIG. 5 is a diagram of the screen display of another embodiment of the present invention video program menu system;

FIG. 6 is diagram of the screen display of the homepage of the present invention video program menu system;

FIG. 7 is diagram of a menu control device of the present invention video program menu system; and

FIG. 8 is an operating flow chart of the menu control device of the present invention video program menu system.

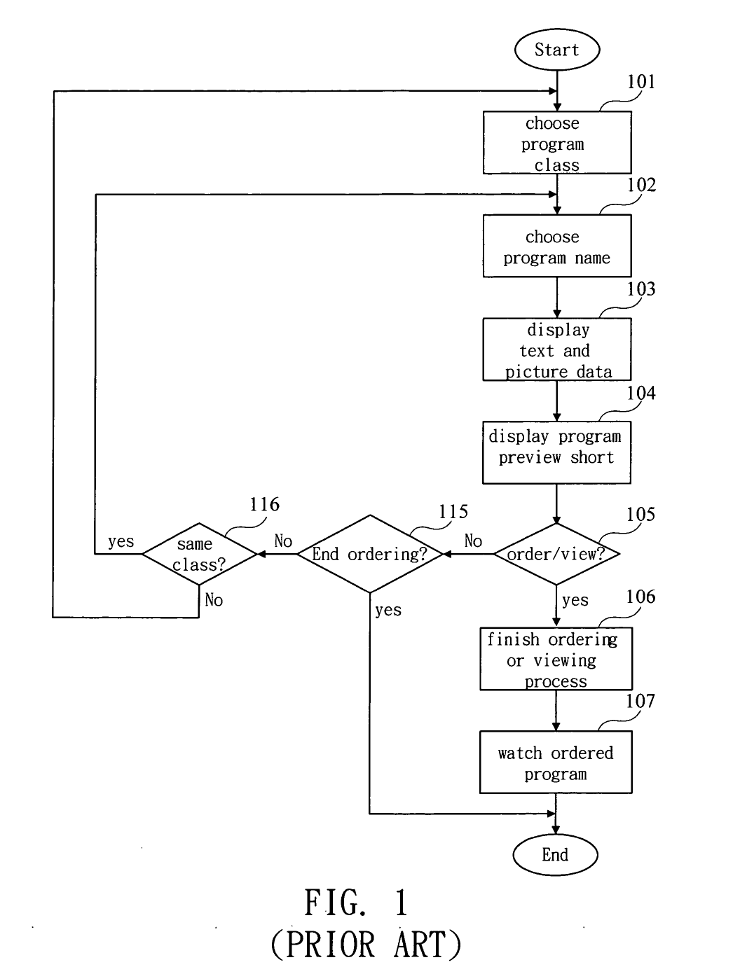

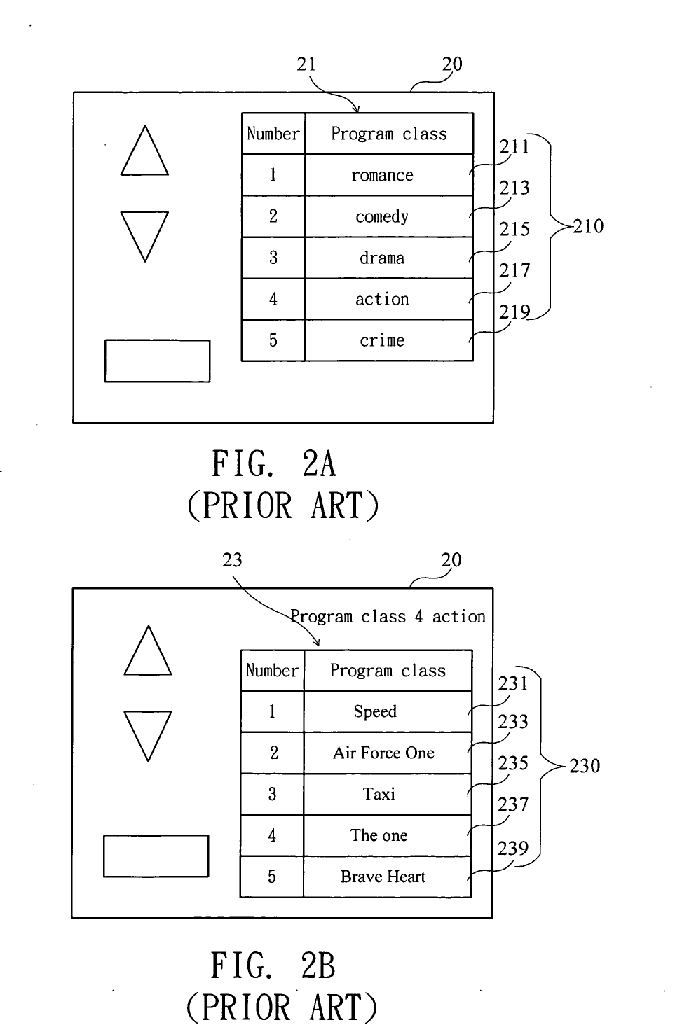

### DETAILED DESCRIPTION

The structural features and the effects to be achieved may further be understood and appreciated by reference to the presently preferred embodiments together with the detailed description.

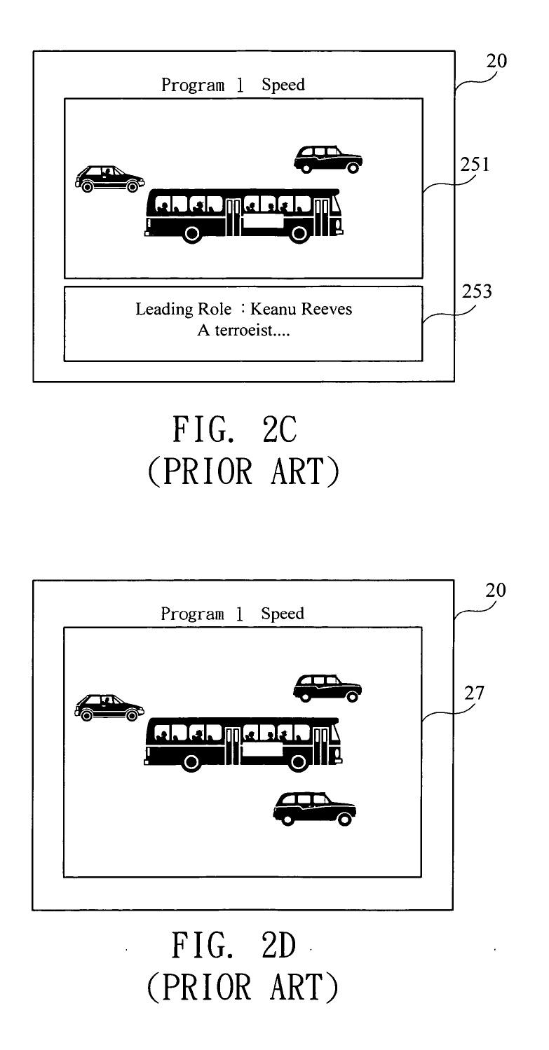

Firstly, referring to FIG. 3A, shows a diagram of the screen display of a preferred embodiment of the present invention video program menu system. As illustrated in this figure, when a consumer wants to proceed VOD or IPG system in a state of a display screen 30 being on, a pre-stored content of a memory 417 of a video converting device 41 will appear on the display screen 30 at the same time. It can include a main menu 31 and a sub-menu 33 wherein the main menu 31 includes a plurality of program class name fields 310, for example, as shown in FIG. 3A, romance 311, comedy 313, drama 315, popular 317, crime 319, etc. The sub-menu 33 includes a plurality of program data display sections 330, such as Taxi 331, Air Force One 332, Speed 333, The One 334, Brave Heart 335, MIB 336, Titanic 337, Hitler 338, and a program preview display section wherein the plurality of program data display sections 330 are arranged at peripheral positions around the sub-menu 33, and central position of the sub-menu 33 surrounded by the program data display sections 330, Taxi 331, Air Force One 332, Speed 333, The One 334, Brave Heart 335, MIB 336, Titanic 337, Hitler 338, is a program preview display section 35.

Further, the main menu 31 is part content of a video on demand program data 535. The video on demand program data 535 is stored in a program database 53 of a video server 50, then processed and stored in a memory 417 by a video controller 51, a transferring line, a video receiver 411 of a video converting device 41, and an internal signal processor 415, and shown on the screen display 30.

Of course, the previous mentioned video converting device 41 can be built-in the screen display 30 during the manufacturing process of the screen display 30 to further reduce the entire volume.

The content shown in each sub-menu 33 is decide by the program class name fields 310 (311, 313, 315, 317, and 319) chosen in the main menu 31, as shown in the main menu 31 in the figure wherein the chosen program class name field 310 is popular 317, so the sub-menu 33 shows the content pre-stored and set in the popular 317. The content can include one of the corresponding text description, picture display, movie preview, and a combination thereof of the programs Taxi 331, Air Force One 332, Speed 333, The One 334, Brave Heart 335, MIB 336, Titanic 337, and Hitler 338. The content of the program preview display section 35 is decided by the program chosen in the program data display section (331, 332, 333, 334, 335, 336, 337, and 338). In the figure, the chosen program data display section is Speed 333, so the program preview display section 35 has the corresponding text description section 351 and short preview section 355 of the program Speed. The text description section 351 will show program data 353, e.g. content introduction, director, actor/actress in a leading role, length of movie, playing time, or movie rate, etc., and the short preview section 355 will show a program preview short 357.

Further, referring to FIG. 3B, shows a diagram of the screen display of the present invention video program menu system in operating process. As shown in the figure, when the cursor is moved to Air Force One 332 from Speed 333, the content shown in the program preview display section 35 will change accordingly. However, in operation, the corresponding program description in other program data display sections (331, 332, 333, 334, 335, 336, 337, and 338) still exist. Therefore, it is not only convenient for the consumer to choose and view, but force the consumer to notice other programs, movies, or program preview shorts to achieve an object of the program or movie advertisements having the best performance.

Of course, in another embodiment of the present invention, the short preview section 355 can be designed as a picture preview section 355 to show the pictures of the program, such as advertising post, etc.

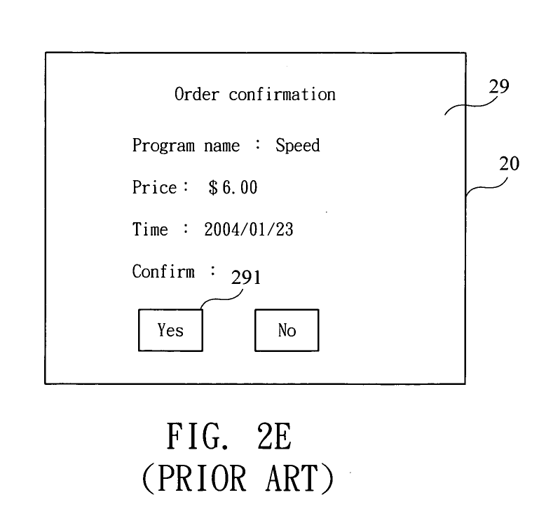

Furthermore, referring to FIG. 4, shows a diagram of the screen display of another embodiment of the present video program menu system. As shown in the figure, the program preview display section 37 at the central of the sub-menu 33 can also be designed to only play a program preview short 377. The consumer can preview the short film of the program and decide whether to watch or buy the program.

Further, if the amount can be shown in the program data display sections (331, 332, 333, 334, 335, 336, 337, and 338) is not enough to show all programs preset in the program class name field 317, page change keys 341 and 343 can be shown in the program data display sections. By the page change keys 341 and 343, the page number of the sub-menu 33 can be overwritten to show all preset program data in the program class name field 317

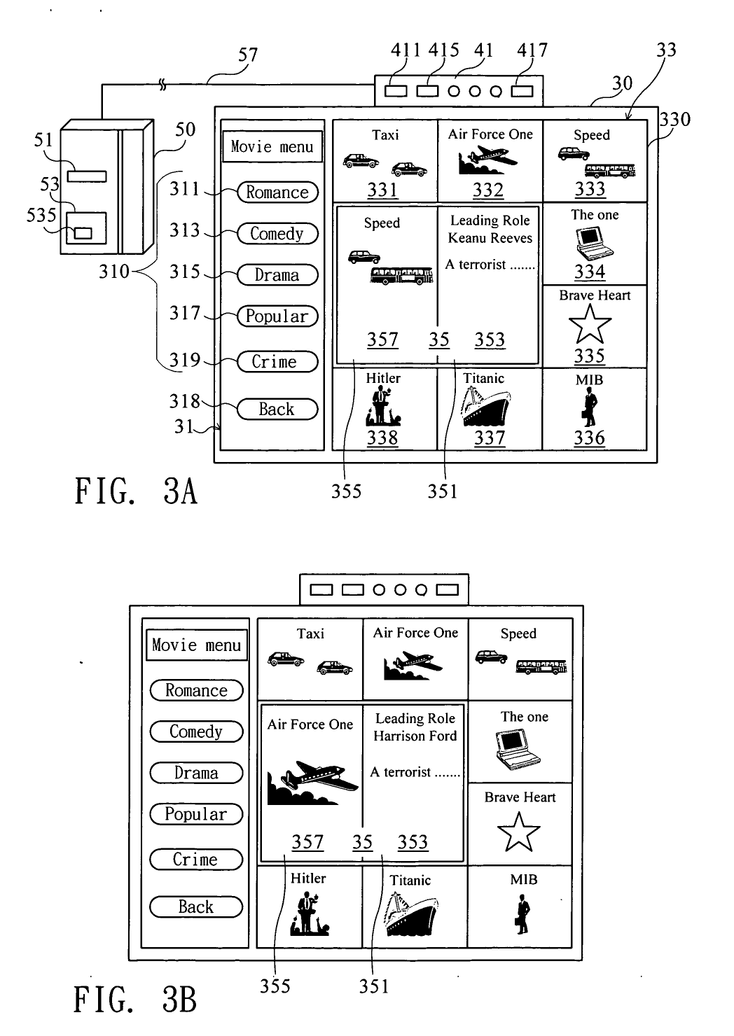

Next, referring to FIG. 5, shows a diagram of the screen display of another embodiment of the present invention video program menu system. As shown in the figure, the program preview display section 39 can be increased by the size of the screen display 30, and program data 393, e.g. the content introduction, director, actor/actress in a leading role, length of movie, playing time, or movie rate, etc., picture 395, and program preview short 397 of the program Speed are all shown in the program preview display section 39 at the same time to achieve the best efficacy of the data display.

In the previous embodiment, the program class name fields 310 (311, 313, 315, 317, and 319) of the main menu 31 and the program data display sections 330 (331, 332, 333, 334, 335, 336, 337, and 338) and the program preview display section 39 of the sub-menu 33 are all shown in the screen display 30 at the same time, so the consumer can know all information and content of the program in the same screen. Also, the size program preview display section 39 can be adjusted in use, for example, previewing the picture or movie by the way of full-screen, to provide the consumer better enjoyment in visual.

Also, in another embodiment of the present invention, the main menu 31 at the side of the display screen 30 can be moved to the previous page so that the main menu 31 and the sub-menu 33 are in two different interfaces, not shown in the display screen 30 at the same time.

Also, in this embodiment, if the program or movie to be watched is a pay system, the consumer can know the program content directly from the program preview display section 39, not only simplifying the viewing and choosing process of the consumer, but also ordering through the order confirmation frame (not shown) appearing in the display screen 30 to make an order in order to operate or choose ordered program or movie content more conveniently.

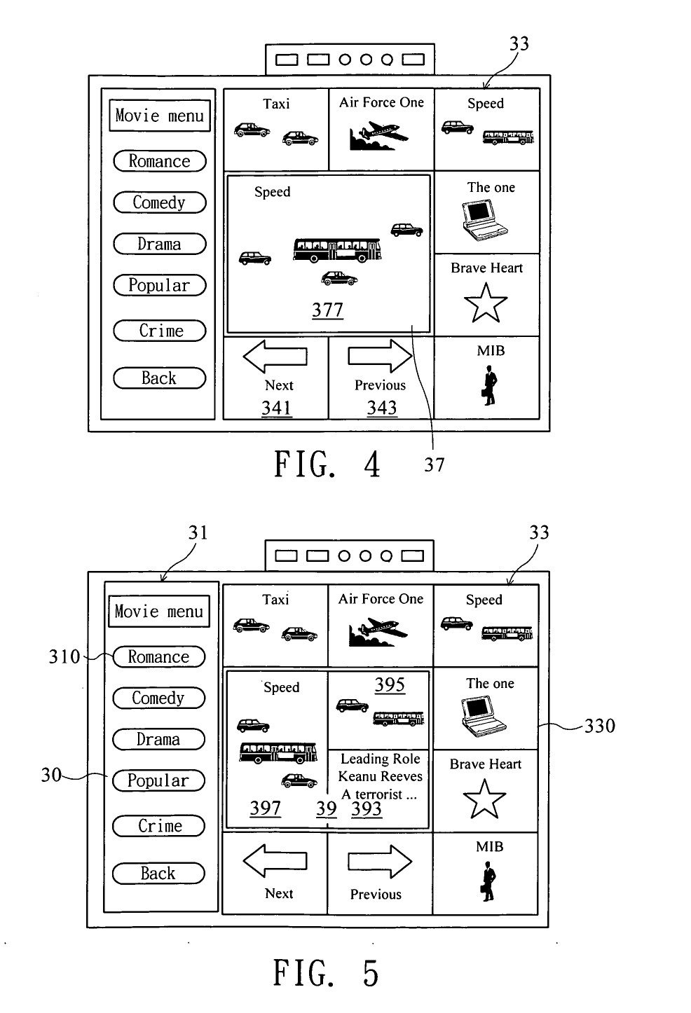

Of course, in the previous mentioned embodiment, the design is the main menu 31 is an upper layer menu and the sub-menu 33 is a lower layer menu. However, in another embodiment of the present invention, above the main menu 33 can be added a homepage menu 61, as shown in FIG. 6. The homepage menu 61 can be not shown in the screen display 30 at the same time as the main menu 31 and sub-menu 33. The content of the homepage menu 61 includes at least one program group name fields 610. The program group name fields 610 are integrity of various types of information and entertainment devices, such as cable channel 611, pay per disk 613, video game 615, network connection 617, etc., for consumers to use. Also, the homepage menu 61 is arranged at an upper layer (page) of the main menu 31, so a specified button of the control device or a back option key 318 in the main menu 31 can be chosen to return to the homepage menu 61.

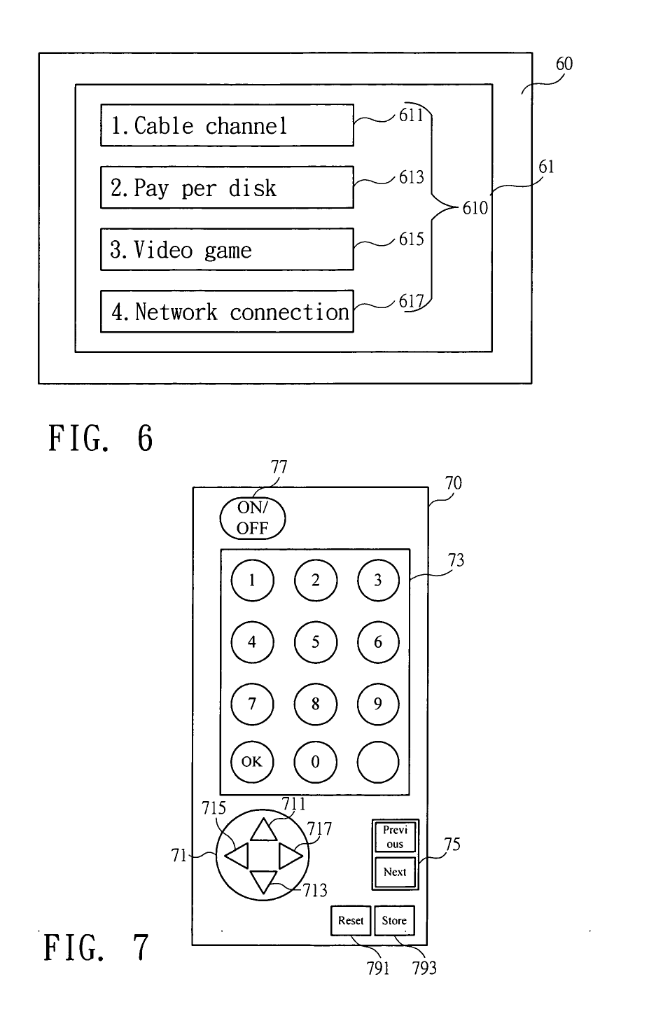

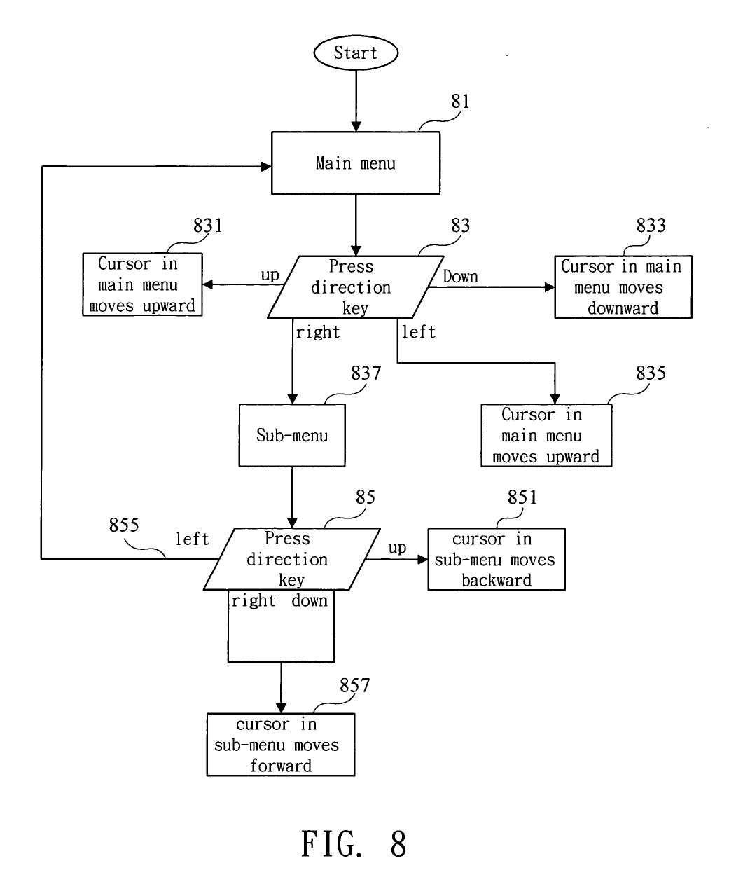

Finally, referring FIG. 3A, FIG. 7, and FIG. 8, a diagram of the screen display, a diagram of the menu control device, and its operating flow chart of a preferred embodiment of the present invention video program menu system. As shown, if the cursor is in action 317 of the main menu 31, as shown in step 81, after pressing a first direction key (such as a up key) 711 of the control device (such as a remote controlling device), the cursor in the main menu 31 will move upward to the drama 315, just as a backward key, as shown in step 831. If pressing a second direction key (such as a down key) 713 of the control device 70, the cursor in the main menu 31 will move downward to the crime 319, just as a forward key, as shown in step 833. If pressing a third direction key (such as a left key) 715 of the control device 70, just as pressing the first direction key (such as the up key) 711, the cursor will move upward as a backward key, as shown in step 835. If pressing a fourth direction key (such as a right key) 717 of the control device 70, the cursor in the main menu 31 will enter into the sub-menu 33 and go into Taxi 331 of the program data display section 330, just as a next page key, as shown in step 837.

After the cursor enters into the sub-menu 33, if pressing the first direction key 711 of the control device, the cursor will move backward in the sub-menu 33, as shown in step 851. At this time, there exist four conditions because of the position of the cursor: if the cursor is at the uppermost layer of the sub-menu 33, the cursor will move leftward; if the cursor is at the lowermost layer of the sub-menu 33, the cursor will move rightward; if the cursor is at the rightmost side of the sub-menu 33, the cursor will move upward; if the cursor is at the leftmost position of the uppermost layer (Taxi 331), the cursor will move to the leftmost position of the lowermost layer (Hitler 355). For example, if the cursor is in the sub-menu 33, and the first direction key 711 of the control device 70 is pressed, if the cursor is at the position of Speed 333, the cursor will move to Air Force One 332; if the cursor is at the position of Hitler 338, the cursor will move to Titanic 337; if the cursor is at the position of MIB 336, the cursor will move the Brave Heart 335; otherwise, if the cursor is at the position of Taxi 331, the cursor will move to Hitler 338.

Similarly, when the cursor is in the sub-menu 33 and the second direction key 713 of the control device 70 is pressed, the cursor will move forward in the sub-menu 33, as shown in step 857. At this time, there exist four conditions because of the position of the cursor: if the cursor is at the uppermost layer of the sub-menu 33, the cursor will move rightward; if the cursor is at the lowermost layer of the sub-menu 33, the cursor will move leftward; if the cursor is at the rightmost side of the sub-menu 33, the cursor will move downward; if the cursor is at the leftmost position of the lowermost layer (Hitler 355), the cursor will move to the leftmost position of the uppermost layer (Taxi 331). For example, if the cursor is in the sub-menu 33, and the second direction key 713 of the control device 70 is pressed, if the cursor is at the position of Hitler 338, the cursor will move to Taxi 331; if the cursor is at the position of MIB 336, the cursor will move to Titanic 337; if the cursor is at the position of Taxi 331, the cursor will move the Air Force One 332; otherwise, if the cursor is at the position of Speed 333, the cursor will move to The One 334.

When the cursor is in the sub-menu 33 and the third direction key 715 of the control device 70 is pressed, the cursor will go back to the main menu 31 of the previous page.

When the cursor is in the sub-menu 33 and the fourth direction key 717 of the control device 70 is pressed, since the sub-menu 33 is the last page, therefore the cursor is like the situation of pressing the second direction key 713 of the control device 70, the cursor will move forward in the sub-menu 33, as shown in step 857.

In the embodiment of the present invention, the functions of the first direction key 711, the second direction key 713, the third direction key 715, and the fourth direction key 717 of the menu control device 70 depend on the position of the cursor. Beside, in use, the same problem in prior art will not be caused in which when the cursor was at the position of the border, after pressing some direction keys, the cursor did not react. Besides, the cursor in the program data menu 330 of the sub-menu 33 moves by the way of a round loop, thus the user can only use any one direction key 71 to control the cursor to any position of the program data display sections (331, 332, 333, 334, 335, 336, 337, and 338).

Also, in the previous mentioned embodiment, the user also can classify or edit cable TV channel, pay per view, and pay channel, etc. according to user's habits by a reset key 791, store key 793, and numeral keys 73 of the menu control device 70. This way, the program content need can be faster to handle and search.

In the previous embodiment, the menu control device 70 can also add a page switch key 75 in order to switch the pages directly by the menu control device 70. Also, a video program menu switch button 77 in the menu control device 70 can be pressed depending on the need of the users to shut off the video program menu system and return to original program manipulating interface and method. Also, the menu control device 70 can be a remote controlling device or a wired controlling device, mouse, and keyboard, etc. to proceed the windows operating.

Also, in the previous mentioned embodiment, the design of the direction keys 71 of the menu control device 70 mainly takes an example for the present invention video program menu system. However, it can be suitable using in menu system interfaces in market.

Of course, in the previous mentioned embodiment, it is mainly written for pay programs or pay movies, such general hotels. However, it can be used in general channel vendors of cable TV or TV program vendors. The program class name fields (311, 313, 315, 317, and 319) of the main menu 31 can be classified by the content of each channel. In the program data display sections (331, 332, 333, 334, 335, 336, 337, and 338) of the sub-menu 33, the representative picture, text, or content display, etc. of each program can be shown. Besides, the classification can choose preset content according to different arrangement of the cable TV system channels in each area, can modify the class content according to the habit of the users for consumers to find out the programs to be watched quickly, and can switch and choose the channels according to the memorized channel numbers to press the numeral keys 73 directly.

The transferring line 57 of the previous mentioned embodiment can be chosen as a satellite line, telephone line, cable or optic-fiber network, coaxial network, microwave network, or infrared transferring line. Also, the video converting device 41 connecting to the display screen 30 can also be a set top box or video recorders, etc.

Further, the present invention is not limited to be used in a VOD or IPG system. It can be used in the video systems, such as movies on demand (MOD), karaoke on demand (KOD), information on demand (IOD), distance learning, videoconference, interactive games, or multimedia on demand (MOD).

The foregoing description is merely one embodiment of present invention and not considered as restrictive. All equivalent variations and modifications in process, method, feature, and spirit in accordance with the appended claims may be made without in any way from the scope of the invention.

1. A video program menu system, comprising:
a video converting device for receiving at least one video on demand program data comprising at least one signal receiver, at least one signal processor, and at least one storage device;
a display screen connected to said video converting device;
a main menu arranged in part area on said display screen, providing a plurality of program class name fields, and through a menu control device operating to choose one of said program class name fields; and
a sub-menu arranged in an area on said display screen without arranging said main menu, display content of said sub-menu capable of displaying content of said program class name field of said main menu, a plurality of data display sections set in part area of said sub-menu, and a program preview display section further set in a place of said sub-menu without arranging said data display sections.

2. The video program menu system according to claim 1, wherein said main menu can be arranged at a side position of said display screen.

3. The video program menu system according to claim 1, wherein said program data display section can be arranged at a peripheral position around said sub-menu, and said program preview display section is set at a central position of said sub-menu around which said program data display section is arranged.

4. The video program menu system according to claim 1, wherein said main menu and said sub-menu can be displayed on said screen display at the same time.

5. The video program menu system according to claim 1, wherein said main menu and said sub-menu can be displayed on said screen display individually.

6. The video program menu system according to claim 1, wherein said program data display section can be chosen to display one of name, content, text description, picture display, video preview, and a combination thereof of said program.

7. The video program menu system according to claim 1, wherein said program preview display section can be chosen to display one of name, content, text description, picture display, video preview, and a combination thereof of said program.

8. The video program menu system according to claim 1, wherein said program preview display section can be adjusted to full-screen display with the same size of said display screen by a specified operating step.

9. The video program menu system according to claim 1, wherein said content of said program class name field can be changed according to preferences of uses.

10. The video program menu system according to claim 1, wherein a homepage menu is provided on an upper layer of interface of said main menu, and a back option is provided in said main menu or menu control device in order to go back to said homepage.

11. The video program menu system according to claim 10, wherein at least one program group name fields are provided on said homepage menu, and corresponding main menu and sub-menu interfaces can be entered by choosing one of said group classes.

12. The video program menu system according to claim 1, wherein a switch button is provided on said menu control device.

13. The video program menu system according to claim 1, wherein said display screen further comprises an order confirmation frame in order to display an order menu.

14. A menu control device capable of operating in said video program menu system according to claim 1, comprising:
a first direction key which a cursor is controlled to move upward by pressing when said cursor is at said main menu or which said cursor moves backward according to an order of said program data display section by pressing when said cursor is at said sub-menu;
a second direction key which said cursor is controlled to move downward by pressing when said cursor is at said main menu or which it moves forward according to an order of said program data display section by pressing when said cursor is at said sub-menu;
a third direction key which said cursor is controlled to move upward by pressing when said cursor is at said main menu or which said cursor moves to said main menu by pressing when said cursor is at said sub-menu;
a fourth direction key which said cursor is controlled to said sub-menu by pressing when said cursor is at said main menu or which said cursor forward according to an order of said program data display section by pressing when said cursor is at said sub-menu.

15. The menu control device of the video program menu system according to claim 14, wherein said cursor shift can be designed to have a loop system.
